(19) United States
(12) Patent Application Publication
(10) Pub. No.: US 2026/0355623 A1
(43) Pub. Date: Nov. 12, 2026

(54) METHODS AND SYSTEMS FOR IMPLEMENTING SING-A-LONG IN VEHICLES

(71) Applicant: GM GLOBAL TECHNOLOGY OPERATIONS LLC, Detroit, MI (US)

(72) Inventors: Harshal Shah, South lyon, MI (US); Katul Patel, Troy, MI (US); Lionel Uzan, Hadera (IL)

(73) Assignee: GM GLOBAL TECHNOLOGY OPERATIONS LLC, Detroit, MI (US)

(21) Appl. No.: 19/202,323

(22) Filed: May 8, 2025

(51) Int. Cl. A63F 13/46; A63F 13/215; A63F 13/40; G10H 1/00; G10H 1/36; G10L 21/028; B60Q 9/00

(52) U.S. Cl. CPC A63F 13/46; A63F 13/215; A63F 13/40; G10H 1/0008; G10H 1/361; G10L 21/028; B60Q 9/00; G10H 2210/005; G10H 2210/066; G10H 2210/076; G10H 2210/091; G10H 2250/311

(57) ABSTRACT

In exemplary embodiments, methods and systems are provided that include sensors, a processor, speakers, and microphones of a vehicle. The sensors are configured to obtain inputs from passengers of the vehicle as to singing zones for passenger singing along with music of the vehicle, and listening zones for listening to the passenger singing. The processor is coupled to the sensors, and is configured to provide instructions for musical sing-a-long in the vehicle. The speakers are configured to output the music for the passengers in accordance with the instructions provided by the processor. The microphones are configured to capture the passenger singing from the singing zones in accordance with the instructions provided by the processor. The speakers are further configured to output the passenger signing, overlayed with the music, to the listening zones, in accordance with the instructions provided by the processor.

### TECHNICAL FIELD

The technical field generally relates to vehicles, and more particularly for implementing sing-a-long activities for vehicles.

### BACKGROUND

Certain vehicles have infotainment systems in which music and/or other entertainment is provided for occupants of the vehicle. In certain situations it may be desirable to provide sing-a-long activities for the occupants of the vehicle.

Accordingly, it is desirable to provide improved methods and systems for implementing sing-a-long activities for occupants of a vehicle.

### SUMMARY

In accordance with an exemplary embodiment, a method is provided that includes obtaining, via one or more sensors, inputs from one or more passengers of a vehicle as to one or more singing zones for passenger singing along with music of the vehicle, and one or more listening zones for listening to the passenger singing; outputting the music for the one or more passengers, via one or more speakers of the vehicle in accordance with instructions provided by a processor of the vehicle; capturing the passenger singing from the one or more singing zones, via one or more microphones of the vehicle in accordance with the instructions provided by the processor; and outputting the passenger signing, overlayed with the music, to the one or more listening zones, via the one or more speakers in accordance with instructions provided by the processor.

Also in an exemplary embodiment, the method further includes performing, via the processor, voice processing for the passenger singing, thereby separating the passenger singing from other sounds including echoes of the music.

Also in an exemplary embodiment, the method further includes providing, via the processor, a sing-a-long game for the one or more passengers, in which the one or more passengers perform the singing along with the music as part of the sing-a-long game; calculating, via the processor, a score for each of the one or more passengers, or for groups of the one or more passengers, based on the passenger singing of each of the one or more passengers or groups of passengers; and providing, via the processor, instructions for outputting the score for the one or more passengers.

Also in an exemplary embodiment, the method further includes obtaining, via the one or more sensors of the vehicle, sensor data as to one or more environmental conditions in proximity to the vehicle; and controlling, via the processor, the sing-a-long game based at least in part of the one or more environmental conditions.

Also in an exemplary embodiment, the calculating of the scoring is performed based on a comparison, via the processor of a passenger pitch of the passenger singing versus an original pitch of an original singer associated with the music.

Also in an exemplary embodiment, the calculating of the scoring is performed based on a comparison, via the processor of a passenger beat of the passenger singing versus an original beat of an original singer associated with the music.

Also in an exemplary embodiment, the calculating of the scoring is performed based on a comparison, via the processor of a passenger word accuracy of lyrics of the passenger singing versus an original word accuracy of lyrics of an original singer associated with the music.

Also in an exemplary embodiment, the calculating of the scoring is performed based on a weighted average of the following comparisons, each performed by the processor via machine learning using a neural network model and a signal processing method: a first comparison of a passenger pitch of the passenger singing versus an original pitch of an original singer associated with the music; a second comparison of a passenger beat of the passenger singing versus an original beat of the original singer associated with the music; and a third comparison of a passenger word accuracy of lyrics of the passenger singing versus an original word accuracy of lyrics of the original singer associated with the music.

Also in an exemplary embodiment, the method further includes providing, via the processor, light enhancements that include illumination of ambient lights inside the vehicle in accordance with a first color for the one or more singing zones, and a second color that is different from the first color for the one or more listening zones.

In another exemplary embodiment, a system is provided that includes one or more sensors, a processor, one or more speakers, and one or more microphones of a vehicle. The one or more sensors are configured to obtain inputs from one or more passengers of the vehicle as to one or more singing zones for passenger singing along with music of the vehicle, and one or more listening zones for listening to the passenger singing. The processor is coupled to the one or more sensors, and is configured to provide instructions for musical sing-a-long in the vehicle. The one or more speakers are configured to output the music for the one or more passengers in accordance with the instructions provided by the processor. The one or more microphones are configured to capture the passenger singing from the one or more singing zones in accordance with the instructions provided by the processor. The one or more speakers are further configured to output the passenger signing, overlayed with the music, to the one or more listening zones, in accordance with the instructions provided by the processor.

Also in an exemplary embodiment, the processor is further configured to at least facilitate performing voice processing for the passenger singing, thereby separating the passenger singing from other sounds including echoes of the music.

Also in an exemplary embodiment, the processor is further configured to at least facilitate providing a sing-a-long game for the one or more passengers, in which the one or more passengers perform the singing along with the music as part of the sing-a-long game; calculating a score for each of the one or more passengers, or for groups of the one or more passengers, based on the passenger singing of each of the one or more passengers or groups of passengers; and providing instructions for outputting the score for the one or more passengers.

Also in an exemplary embodiment, the one or more sensors are further configured to obtain sensor data as to one or more environmental conditions in proximity to the vehicle; and the processor is further configured to at least facilitate controlling the sing-a-long game based at least in part of the one or more environmental conditions.

Also in an exemplary embodiment, the processor is further configured to at least facilitate calculating the scoring based on a comparison, via the processor of a passenger pitch of the passenger singing versus an original pitch of an original singer associated with the music.

Also in an exemplary embodiment, the processor is further configured to at least facilitate calculating the scoring based on a comparison of a passenger beat of the passenger singing versus an original beat of an original singer associated with the music.

Also in an exemplary embodiment, the processor is further configured to at least facilitate calculating the scoring based on a comparison of a passenger word accuracy of lyrics of the passenger singing versus an original word accuracy of lyrics of an original singer associated with the music.

Also in an exemplary embodiment, the processor is further configured to at least facilitate calculating the scoring is performed based on a weighted average of the following comparisons, each performed by the processor via machine learning using a neural network model and a signal processing method: a first comparison of a passenger pitch of the passenger singing versus an original pitch of an original singer associated with the music; a second comparison of a passenger beat of the passenger singing versus an original beat of the original singer associated with the music; and a third comparison of a passenger word accuracy of lyrics of the passenger singing versus an original word accuracy of lyrics of the original singer associated with the music.

Also in an exemplary embodiment, the processor is further configured to at least facilitate providing light enhancements that include illumination of ambient lights inside the vehicle in accordance with a first color for the one or more singing zones, and a second color that is different from the first color for the one or more listening zones.

In another exemplary embodiment, a vehicle is provided that includes a body, a propulsion system, one or more sensors, a processor, one or more speakers, and one or more microphones. The propulsion system is disposed within the body, and is configured to move the vehicle. The one or more sensors are configured to obtain inputs from one or more passengers of the vehicle as to one or more singing zones for passenger singing along with music of the vehicle, and one or more listening zones for listening to the passenger singing. The processor is coupled to the one or more sensors, and is configured to provide instructions for musical sing-a-long in the vehicle. The one or more speakers are configured to output the music for the one or more passengers in accordance with the instructions provided by the processor. The one or more microphones are configured to capture the passenger singing from the one or more singing zones in accordance with the instructions provided by the processor. The one or more speakers are further configured to output the passenger signing, overlayed with the music, to the one or more listening zones, in accordance with the instructions provided by the processor. The processor is further configured to at least facilitate performing voice processing for the passenger singing, thereby separating the passenger singing from other sounds including echoes of the music; providing a sing-a-long game for the one or more passengers, in which the one or more passengers perform the singing along with the music as part of the sing-a-long game; calculating a score for each of the one or more passengers, or for groups of the one or more passengers, based on the passenger singing of each of the one or more passengers or groups of passengers; and providing instructions for outputting the score for the one or more passengers.

Also in an exemplary embodiment, the processor is further configured to at least facilitate calculating the scoring is performed based on a weighted average of the following comparisons, each performed by the processor via machine learning using a neural network model and a signal processing method: a first comparison of a passenger pitch of the passenger singing versus an original pitch of an original singer associated with the music; a second comparison of a passenger beat of the passenger singing versus an original beat of the original singer associated with the music; and a third comparison of a passenger word accuracy of lyrics of the passenger singing versus an original word accuracy of lyrics of the original singer associated with the music.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for implementing sing-a-long activities for occupants of the vehicle, in accordance with an exemplary embodiment;

FIG. 2 is a flowchart of a process for implementing sing-a-long activities for occupants of the vehicle, and that can be implemented in connection with the vehicle of FIG. 1, including the control system and other components thereof, in accordance with an exemplary embodiment; and

FIGS. 3-7 are flow diagrams implementing exemplary implementations of the process of FIG. 2, in accordance exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

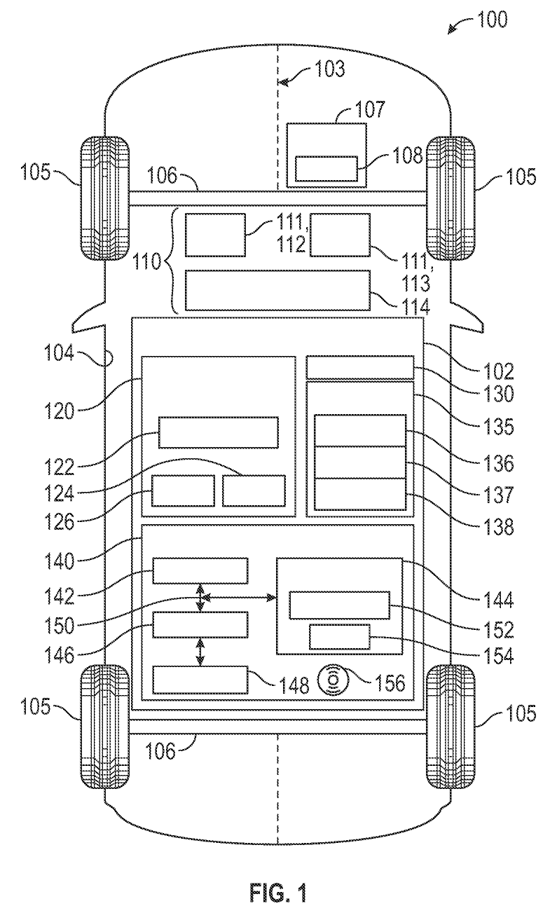

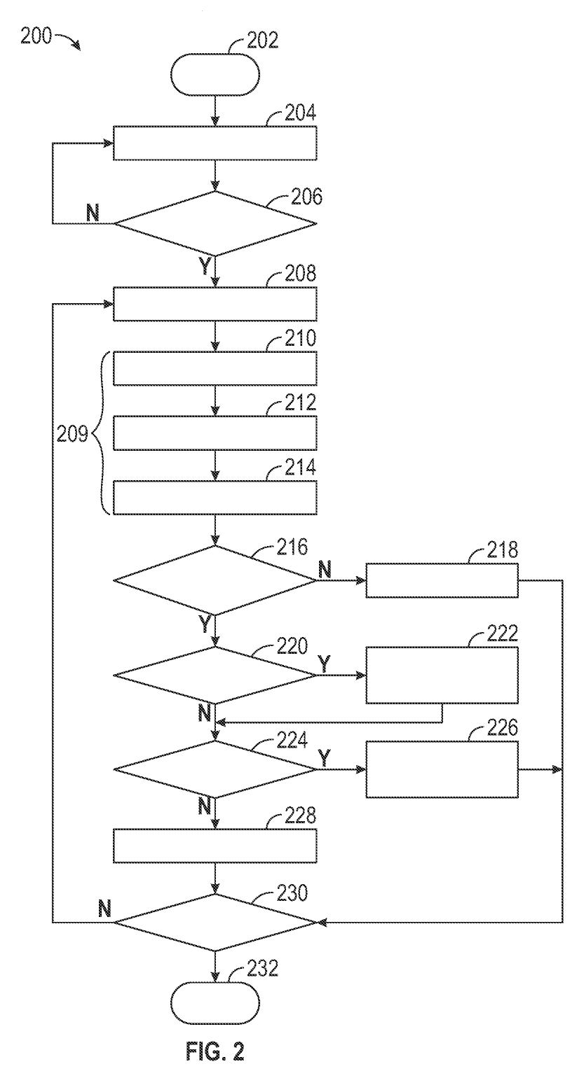

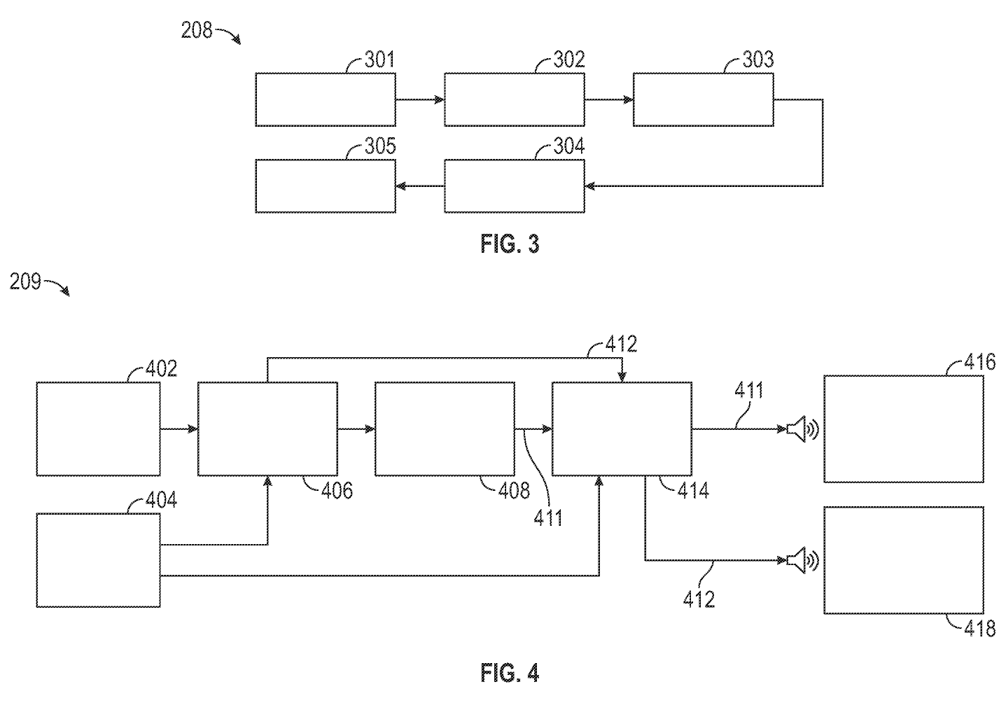

FIG. 1 illustrates a vehicle, in accordance with an exemplary embodiment. As described in greater detail further below, in various embodiments the vehicle 100 includes, among other components, a control system 102 for implementing sing-a-long activities for occupants of the vehicle in accordance with the process 200 of FIG. 2 and the implementations of FIGS. 3-7.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

In the depicted embodiment, the vehicle 100 includes a body 104 that is arranged on a chassis 103. The body 104 substantially encloses other components of the vehicle 100. The body 104 and the chassis 103 may jointly form a frame. The vehicle 100 also includes a drive system 107 and a plurality of wheels 105. In various embodiments, the drive system 107 is mounted on the chassis 103, and drives the wheels 105, for example via axles 106, to cause movement and propulsion of the vehicle 100. In various embodiments, the drive system 107 comprises a propulsion system that includes one or more motors 108, such as one or more engines, electronic motors, hybrid motors, and the like.

As depicted in FIG. 1, in various embodiments, the vehicle 100 includes a plurality of seats 110 for occupants of the vehicle 100 to sit while inside the vehicle 100. As used herein, the term “occupants” include a driver (if any) of the vehicle 100 along with any passengers of the vehicle 100. Also as depicted in FIG. 1, in various embodiments, the seats 110 may include front seats 111 and rear seats 114 in various embodiments, and may further be characterized as driver side seats 112 and passenger side seats 113 (in addition to possible middle seats in various embodiments). It will be appreciated that in various embodiments the seats 110 may include individual seats, bucket seats, rows and/or benches of seats, and/or any one or more other types of seats and/or variations thereof.

As noted above, the control system 102 for controls implementation of sing-a-long activities for occupants of the vehicle, in accordance with the process 200 of FIG. 2 and the implementations of FIGS. 3-7. As depicted in FIG. 1, in various embodiments, the control system 102 includes a sensor array 120, a display system 135, a location system 130, and a controller 140.

In various embodiments, the sensor array 120 obtains sensor data pertaining to the vehicle 100, including for use in implementing sing-a-long activities for occupants of the vehicle 100. In various embodiments, the sensor array 120 includes microphones 122 and input sensors 124. In certain embodiments, the sensor array 120 may also include other sensors 126.

In various embodiments, the microphones 122 comprise interior microphones that are disposed inside a cabin of the vehicle 100, in which occupants are disposed. In various embodiments, the microphones 122 are disposed in or proximate a ceiling or headliner of the cabin of the vehicle 100, above respective seats 110 of the vehicle 100. In certain embodiments, different microphones 122 and/or groups of microphones 122 are configured to receive separate and individuals sounds, including passenger singing, from different zones in which passengers are seated.

In various embodiments, the input sensors 124 are configured to obtain passenger inputs from one or more passengers (i.e., occupants) of the vehicle 100, including as to infotainment preferences for the passengers, and including with respect to sing-a-long activities for the passengers inside the vehicle 100. In certain embodiments, the input sensors 124 are part or coupled to one or more display screens of the vehicle, such as a display screen 136 of the display system 135 as described in greater detail further below. In certain other embodiments, the input sensors 124 may received passenger inputs in one or more different manners, such as through voice commands, a designated button and/or other control device, or the like.

As noted above, in certain embodiments, the sensor array 120 may also include one or more other sensors 126. For example, in certain embodiments, the other sensors 126 comprise one or more weather sensors, cameras, and/or other sensors that are configured to obtain sensor data as to environmental conditions, including environmental conditions that may affect sing-a-long activities and/or for which sing-a-long activities may not be appropriate, such as by way of example weather conditions such as rain, fog, or snow, roadside and/or traffic conditions such as being in a construction zone or school zone, or the like.

In various embodiments, the location system 130 obtains location sensor data as to a geographic location of the vehicle 100. In certain embodiments, the location system 130 includes and/or is coupled to a satellite-based system such as a global positioning system (GPS), or the like. In certain embodiments, the location system 130 may comprise or be part of a navigation system for the vehicle 100.

With continued reference to FIG. 1, in various embodiments the display system 135 includes one or more devices and/or systems that provide output information and entertainment, including music and singing by occupants of the vehicle 100 in relation to the music. In certain embodiments, the display system 135 includes the above-referenced display screen 136 that is configured to depict information for the passengers of the vehicle 100, including for obtaining inputs from the passengers as preferences for sing-a-long activities for the vehicle 100, and further providing a display output of instructions and scoring pertaining to game enhancements for the sing-a-long activities.

Also in various embodiments, the display system 135 further includes speakers 137. In various embodiments, the speakers 137 comprise interior microphones that are disposed inside a cabin of the vehicle 100, in which occupants are disposed. In various embodiments, the speakers 137 and/or groups of speakers 137 are configured to provide sound output (including music and in certain instances overlayed with singing of one or more of the passengers) to different zones in which passengers are seated.

In various embodiments, the display system 135 further includes lights 138 that are selectively illuminated within the vehicle 100. In various embodiments, the lights 138 are selectively illuminated in certain prescribed manners (including in relation to the music and to the singing by passengers in different zones of the vehicle 100, and so on).

In certain embodiments, the display system 135 may include one or more other components, such as by way of example, one or more haptic components. For example, in certain embodiments, the display system 135 may include or cause vibration of one or more of the seats 110 (e.g., in relation to the music in certain embodiments), among other possible haptic functions.

In various embodiments, the controller 140 is coupled to the sensor array 120, as well as to the display system 135. In certain embodiments, the controller 140 is also coupled to the drive system 107, the location system 130, and/or one or more other components of the vehicle 100. In various embodiments, the controller 140 controls sing-a-long activities for the passengers of the vehicle 100, including as set forth in the process 200 of FIG. 2 and the implementations of FIGS. 3-7 in various embodiments

In various embodiments, the controller 140 comprises a computer system, and includes a processor 142, a memory 144, an interface 146, a storage device 148, and a computer bus 150. In various embodiments, the controller (or computer system) 140 obtains sensor data from the sensor array 120, and in certain embodiments additional data via the location system 130 (e.g., as to environmental conditions surrounding the vehicle 100). In various embodiments, the controller 140 processes the data, including passenger inputs as to the sing-a-long activities, and further including singing from one or more of the passengers in different zones, processing the singing along with music pertaining thereto, and outputting resulting music and singing to various predesignated zones inside the vehicle (and further including enhancements such as sing-a-long games and lighting effects in certain embodiments). In various embodiments, the controller 140 provides these and other functions in accordance with the steps of the processes and implementations depicted in FIG. 2 and the implementations of FIGS. 3-7.

In various embodiments, the controller 140 (and, in certain embodiments, the control system 102 itself) is disposed within the body 104 of the vehicle 100. In one embodiment, the control system 102 is mounted on the chassis 103. In certain embodiments, the controller 140 and/or control system 102 and/or one or more components thereof may be disposed outside the body 104, for example on a remote server, in the cloud, or other device where image processing is performed remotely. In certain embodiments, the controller 140 of the vehicle 100 also performs functions in concert with the remote server 170, described further below.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process of FIG. 2 and implementations depicted in FIGS. 3-7 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144stores the above-referenced program 152 along with stored values 154 as used in the process of FIG. 2 and implementations depicted in FIGS. 3-7 and as described further below in connection therewith in accordance with exemplary embodiments.

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or from one or more other sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

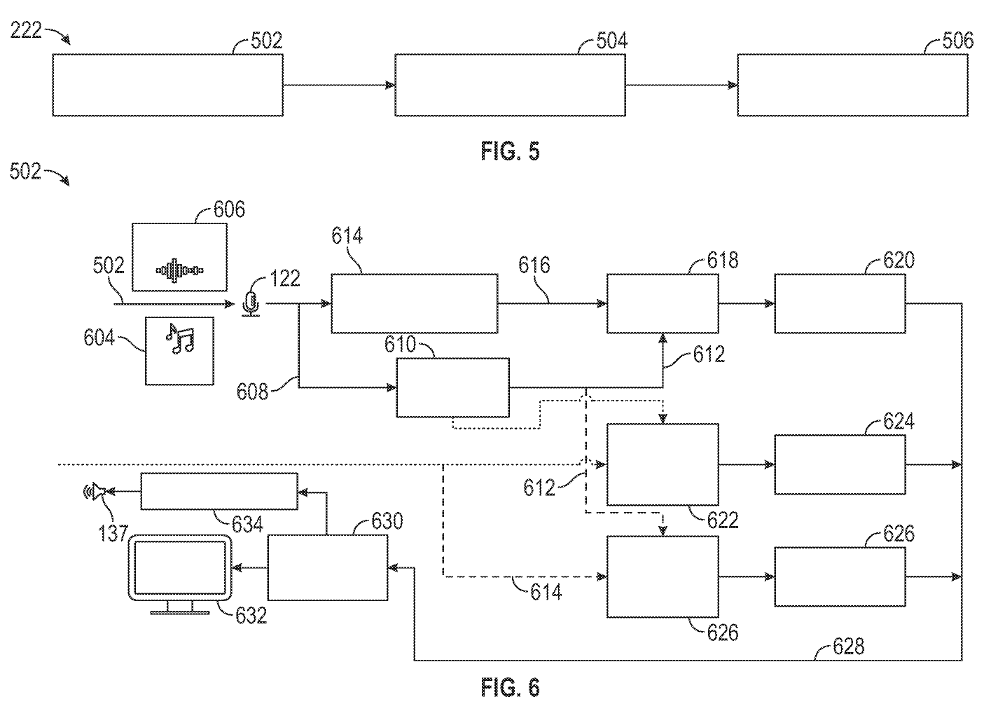

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of the processes and implementations of FIGS. 5 and 6 and as described further below in connection therewith. In another exemplary embodiment, the program product may be directly stored in and/or otherwise accessed by the memory 144 and/or a secondary storage device (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 2 is a flowchart of a process 200 for implementing sing-a-long activities for occupants of a vehicle, in accordance with an exemplary embodiment. In various embodiments, the process 200 can be implemented in connection with the vehicle 100 of FIG. 1, including the control system 102 and other components thereof. The process 200 is described below in connection with FIG. 2 as well as in connection with FIGS. 3-7, which depict exemplary implementations of the process 200 of FIG. 2.

As depicted in FIG. 2, in an exemplary embodiment the process 200 begins at 202. In an exemplary embodiment, the process 200 begins when the vehicle 100 (e.g., the motor 108 of the drive system 107 thereof) is turned on, and/or when passengers are disposed within the vehicle 100 (e.g., during a vehicle drive). In various embodiments, the steps of the process 200 are performed, preferably continuously, as long as the motor 108 is turned on with passengers in the vehicle 100 (e.g., during a vehicle drive).

In various embodiments, sensor data is obtained (step 204). In various embodiments, sensor data is obtained via one or more sensors of the sensor array 120. Specifically, in various embodiments, input sensor data is obtained via the input sensors 124 from passengers of the vehicle 100, including as to whether the passengers desire to engage in sing-a-long activities. In addition, in certain embodiment, the user inputs also pertain to (i) specific singing zones inside the vehicle 100 (e.g., pertaining to specific passenger seats 110) for passengers that are to participate in the singing; and (ii) specific listening zones inside the vehicle 100 (e.g., pertaining to specific passenger seats 110) for passengers that will hear the output of the singing overlayed against the music. In addition, in certain embodiments, the sensor data of step 204 further includes additional sensor data as to environmental conditions and/or circumstances surrounding the vehicle 100 that may affect participation in the sing-a-long (e.g.,. weather conditions such as rain or snow, roadway conditions such as a construction zone or school zone, and so on).

In various embodiments, a determination is made as to whether sing-a-long activities are to be conducted (step 206). In various embodiments, this determination is made by the processor 142 of FIG. 1 based on the sensor data of step 204. Specifically, in certain embodiments, the processor 142 determines that sing-a-long activities are to be conducted when both of the following conditions are satisfied, namely: that (i) one or more passengers have requested that sing-a-long activities be conducted; and (ii) there are no environmental conditions (e.g., rain, snow, construction zone, school zone, or the like) that could make sing-a-long activities inappropriate under the circumstances.

Also in various embodiments, zone selection is performed (step 208). Specifically, in various embodiments, the processor 142 selects both (i) specific singing zones for passengers that are to participate in the singing; and (ii) specific listening zones inside for passengers that will hear the output of the singing overlayed against the music, pursuant to the user instructions of the sensor data of step 204.

With reference now to FIG. 3, an exemplary implementation of the zone selection of step 208, is depicted in connection with an exemplary embodiment, and is described below in connection therewith.

As depicted in FIG. 3, in an exemplary embodiment, singing zones 301 are selected and implemented. In certain embodiments, specific singing zones 301 in the cabin of the vehicle 100 are designated where passengers can sing (i.e., corresponding to the user inputs for preferences as part of step 204 as described above). In various embodiments, the voices of the passengers in the singing zones are captured by respective microphones 122 of the singing zones 301.

Also as depicted in FIG. 3, in an exemplary embodiment, listening zones 302 are selected and implemented. In certain embodiments, specific listing zones 302 in the cabin of the vehicle 100 are designated where passengers can listen to the singing voices from the passengers in the singing zones 301, thereby creating an interactive experience. In various embodiments, the singing voices of the passengers in the singing zones are outputted to the listening zones 302 captured by respective speakers 137 of the listening zones 302.

Also as depicted in FIG. 3, in an exemplary embodiment, customizable zones 303 are also selected and implemented. In certain embodiments, the passengers are allowed to customize the singing zones 301 and listening zones 302 based on their personal preferences. Specifically, in certain embodiments, the passengers can choose which zones are singing and which zones are listening at any given time.

Also as depicted in FIG. 3, in an exemplary embodiment, zone switching 304 may also be selected and implemented when requested by the passengers. In certain embodiments, the passengers are allowed to switch roles (i.e., singing versus listening) seamlessly, including during a particular song.

Also as depicted in FIG. 3, in an exemplary embodiment, a private mode 305 may also be implemented. In certain embodiments, as part of a private mode 305, a particular singer can hear their own voice (e.g., via headphones) while other passengers listen to the original musical alone (i.e., without hearing the singing form the singing passenger).

With reference back to FIG. 2, in various embodiments, singing sounds are captured (step 210). Specifically, in various embodiments, singing sounds are captured from passengers in the specific singing zones as selected in step 208. Also in various embodiments, the singing sounds are captured by respective microphones 122 of the singing zones in accordance with instructions provided by the processor 142.

Also in various embodiments, processing of the singing sounds is performed (step 212). Specifically, in certain embodiments, the vocalized singing sounds of the one or more passengers in the one or more singing zones is extracted from other sounds for processing by the processor 142.

In addition, in various embodiments, singing output is provided (step 214). Specifically, in various embodiments, the processed singing sounds from the singers of the singing zones are then outputted to certain users of the vehicle 100 who are sitting in passenger seats 110 of the listening zones as selected in step 208. Also in various embodiments, this output of the singing sounds to the listening zones is performed via respective speakers 137 corresponding to the listening zones in accordance with instructions provided by the processor 142.

As depicted in FIG. 2, in certain embodiments steps 210-214 of the process 200 of FIG. 2 may be collectively referred to as sub-process 209 for implementing the zone selection.

With reference now to FIG. 4, an exemplary implementation of the sub-process 209 of implementing the zone selection is depicted in connection with an exemplary embodiment, and is described below in connection therewith.

As depicted in FIG. 4, in an exemplary embodiment, a singing zoning request is made (step 402). In an exemplary embodiment, the singing zone request is made (e.g., on the display screen 136 in certain embodiments) by one or more passengers who request to sing along with the music.

Aso as depicted in FIG. 4, in an exemplary embodiment, a listening zoning request is made (step 404). In an exemplary embodiment, the listening zone request is made (e.g., on the display screen 136 in certain embodiments) by one or more passengers who request to listen to the passenger singing.

Also as depicted in FIG. 4, the singing zone request and the listening zone request are received (step 406), namely by the processor 142. In various embodiments, the processor 142 implements a voice processing algorithm for the sing-a-long, in a manner that captures the microphone 122 data from selected zones (i.e., the singing zones) and removes any echo sounds (e.g., any unwanted music playback).

In various embodiments, separate channels are provided for the resulting sounds (step 414). Specifically, in certain embodiments, a first channel 411 of sound is provided for the passenger singing (overlayed with the original music, in certain embodiments), and a second channel 412 of sound is provided for the music itself (i.e., without the passenger singing). In certain embodiments, passengers in the listening zone hear the singing from the passenger singing from the singing zone (overlayed with the original music, in certain embodiments) via the first channel 411 (step 416), whereas the passengers in other zones only hear the original music playback (i.e., without the passenger singing) via the second channel 412 (step 418).

With reference back to FIG. 2, in an exemplary embodiment, a determination is made as to whether any enhancements are requested for the sing-a-long activities (step 216). In various embodiments, enhancements may include playing a sing-a-long game, light enhancements to accompany the sing-a-long, or both. Also in various embodiments, this determination is made by the processor 142 based on the user inputs of the sensors data of step 204.

In various embodiments, if it is determined at step 216 that enhancements are not requested, then the process proceeds to step 218. In various embodiments, during step 218, the sing-a-long activities (e.g., as described above in connection with the sub-process 209 relating thereto) are performed, without enhancements of a sing-a-long game or light effects. In various embodiments, the process 200 then proceeds to step 230 with a determination as to whether the sing-a-long is complete, as described further below.

Conversely, in various embodiments, if it is instead determined at 216 that one or more enhancements are requested, then a determination is made as to whether a sing-a-long game is requested (step 220). Also in various embodiments, this determination is made by the processor 142 based on the user inputs of the sensors data of step 204.

In various embodiments, if it is determined in step 220 that a sing-a-long game is requested, then game enhancements are provided for the sing-a-long (step 222). Specifically, in various embodiments, a sing-a-long game is provided for the passengers in accordance with instructions provided by the processor 142, including by providing each passenger the opportunity to sing along with the music and to be assigned a score based on their singing efforts and abilities.

Turning now to FIG. 5, an exemplary implementation is depicted for step 222 of FIG. 2 (namely, providing game enhancements for the sing-a-long), in accordance with an exemplary embodiment.

As depicted in FIG. 5, in certain embodiments, group competition is provided at 502. Specifically, in certain embodiments, groups of passengers are created based on different passengers sitting in different zones (e.g., front seat passengers versus rear seat passengers, or the like, and/or members of pre-defined teams based on user inputs, or the like). In various embodiments, the group competition is provided in accordance with instructions provided by the processor 142.

In various embodiments, a scoring system is provided (step 504). Specifically, in certain embodiments, scores of the various groups of singers are calculated by the processor 142 based on factors that include pitch, rhythm, creativity, and accuracy of lyrics, among other possible scoring criteria. Also in various embodiments, the scores are displayed for the passengers on the display screen 136 of FIG. 1.

In addition, in certain embodiments, interactive feedback is provided (step 506). Specifically, in certain embodiments, the processor 142 provides instructions for the display of real-time feedback for the passengers based on their singing, such as on the display screen 136 of FIG. 1 and/or via the speaker 137 of FIG. 1. In certain embodiments, the feedback helps keep the passengers encouraged and engaged in the sing-a-long game.

With reference now to FIG. 6, an exemplary implementation is provided for step 222 as presented in FIGS. 2 and 5, and in particular with respect to the step 502 of group competition, in accordance with an exemplary embodiment.

As depicted in FIG. 6, in an exemplary embodiment, music is played for the passengers (step 604) via one or more speakers 137 of the vehicle 100, and singing vocals are obtained from passengers (step 606) via one or more microphones 122 of the vehicle 100.

In various embodiments, a reference signal 608 (i.e., including the original music of 604, including the original singing of the original singer form the music) is utilized by the processor 142 for source separation (step 610) using a neural network model, yielding as a result the original singer’s vocals 612.

Also in various embodiments, the passenger vocals of 606 are captured by the microphones 122 are analyzed via the processor 142 via a voice processing algorithm (step 614), thereby yielding as a result the passenger’s vocals 616 (i.e., as separated from the music).

In various embodiments, the original singer’s vocals 612 are compared with the passenger’s vocals 616 via the processor 142 using a pitch detection algorithm (step 618). In various embodiments, as part of the pitch detection algorithm, the processor 142 uses a Fast Fourier Transform (FFT) (and/or in certain embodiments one or more other signal processing methods) to analyze the voice frequency and amplitude of the pitch of the passenger’s vocals 616 and compare them with the voice frequency and amplitude of the original singer’s vocals 612. In certain embodiments, one or more other signal processing methods may also be utilized. In various embodiments, this comparison is utilized by the processor 142 in determining a pitch score for the passenger (step 620). In various embodiments, the processor 142 determines the passenger pitch score based on a comparison of the passenger’s pitch versus the original singer’s pitch (including voice frequency and amplitude) using machine learning in combination with a convolutional neural network model (CNN).

Also in various embodiments, the original singer’s vocals 612 are compared with the passenger’s vocals 616 via the processor 142 using a beat detection algorithm (step 622). In various embodiments, as part of the beat detection algorithm, the processor 142 uses a Fast Fourier Transform (FFT) (and/or in certain embodiments one or more other signal processing methods) to analyze the beat, or timing, of the passenger’s vocals 616 and compare them with the voice beat, or timing, of the original singer’s vocals 612. In various embodiments, this comparison is utilized by the processor 142 in determining a beat score for the passenger (step 624). In various embodiments, the processor 142 determines the passenger beat score based on a comparison of the passenger’s beat, or timing, versus the original singer’s beat, or timing using machine learning in combination with a convolutional neural network model (CNN).

Also in various embodiments, the original singer’s vocals 612 are compared with the passenger’s vocals 616 via the processor 142 using a word accuracy algorithm (step 626). In various embodiments, as part of the beat detection algorithm, the processor 142 uses a Fast Fourier Transform (FFT) (and/or in certain embodiments one or more other signal processing methods) to analyze the accuracy of the words of the lyrics of the passenger’s vocals 616 and compare them with the words of the lyrics of the original singer’s vocals 612. In various embodiments, this comparison is utilized by the processor 142 in determining a word accuracy score for the passenger (step 628). In various embodiments, the processor 142 determines the passenger word accuracy based on a comparison of the passenger’s words of the lyrics versus those of the original singer using machine learning in combination with a convolutional neural network model (CNN).

In certain embodiments, the pitch score of step 620, the beat score of step 624, and the word accuracy score of step 628 are aggregated together by the processor 142 to calculate an aggregate score for each singer or group of singers (step 630). In certain embodiments, the scores of steps 620, 624, and 628 are combined during step 630 by applying predetermined weights to the individual scores in generating an aggregate score for each singer or group of singers.

In various embodiments, the scores are outputted for the passengers (step 634). In certain embodiments, the scores are outputted via the speakers 137 and/or the display screen 136 of the vehicle 100 in accordance with instructions provided by the processor 142.

With reference back to FIG. 2, a determination is also made as to whether lighting enhancement is requested for the sign-a-long (step 224). Also in various embodiments, this determination is made by the processor 142 based on the user inputs of the sensors data of step 204.

In various embodiments, if it is determined in step 224 that light enhancements are requested, then light enhancements are provided for the sing-a-long (step 226). Specifically, in various embodiments, the processor 142 provides for selective illumination of the lights 138 along with the music for the sing-a-long (and in certain embodiments along with the sing-a-long game described above). In certain embodiments, the processor 142 provides different colors of the lights 138 in the singing zones versus the singing zones. Also in certain embodiments, the processor 142 provides different colors of the lights 138 for passengers when it is their turn to sing as part of the sing-a-long game.

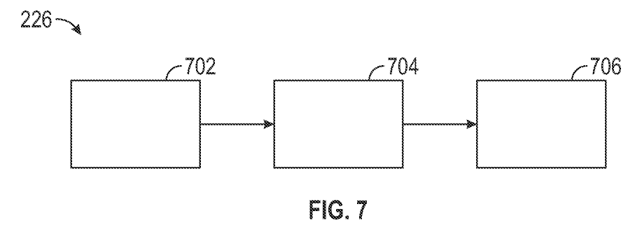

Turning now to FIG. 7, an exemplary implementation is depicted for step 226 of FIG. 2 (namely, providing light enhancements for the sing-a-long), in accordance with an exemplary embodiment.

As depicted in FIG. 7, in various embodiments color coding is provided at step 702. In various embodiments, ambient lighting is used to differentiate between the zones, including the singing zones versus listening zones as described above. In certain embodiments, the singing zones have a vibrant color (e.g., red or blue), whereas the listening zones may have a calming color (e.g., green or purple).

Also as depicted in FIG. 7, dynamic color is provided at step 704. In certain embodiments, the lighting may change dynamically, in accordance with instructions provided by the processor, based on the intensity or volume of the singing, thereby adding a visual element to the sing-a-long experience.

In addition, as depicted in FIG. 7, in various embodiments user-controlled lighting is provided at 706. In certain embodiments, one or more passengers are permitted to control the lighting effects (including colors), for example using touch screen commands, voice commands, a mobile application on a smartphone, or the like.

With reference back to FIG. 2, in various embodiments, if it is determined during step 224 that lighting enhancement is not requested, then standard lighting is provided (step 228), in other words without the lighting effects.

In either case, in various embodiments, the process 200 proceeds to the above-mentioned step 230, in which a determination is made as to whether the sing-a-long activities are complete. In various embodiments, the processor 142 determines that the sing-a-long activities are complete at the end of a current vehicle drive, and/or when current conditions (e.g., as to the weather and/or roadway) are no longer conducive to sing-a-long activities, and/or whether the passengers are no longer requesting sing-a-long activities.

In various embodiments, if it is determined in step 230 that the sing-a-long is complete, then the process returns to step 208 and continues in a new iteration. Conversely, also in various embodiments, when it is determined in an iteration of step 230 that the sing-a-long is complete, then the process terminates at 232.

Accordingly, methods, systems, and vehicles are provided for controlling sing-a-long activities for passengers of a vehicle. In various embodiments, the disclosed methods, systems, and vehicles provide for passengers to designate specific zones in which the singers will participating in the sing-a-long activities, as well as specific zones in which the singing vocals will be outputted. Also in various embodiments, the disclosed methods, systems, and vehicles provide additional sing-a-long activities and enhancements, including sing-a-long games and lighting effects.

It will be appreciated that the systems, vehicles, and methods may vary from those depicted in the Figures and described herein. For example, the vehicle 100, including the control system 102 and other components thereof, may differ from that depicted in FIG. 1. It will similarly be appreciated that the steps of the process of FIG. 2 and the implementations of FIGS. 3-7 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
obtaining, via one or more sensors, inputs from one or more passengers of a vehicle as to one or more singing zones for passenger singing along with music of the vehicle, and one or more listening zones for listening to the passenger singing;
outputting the music for the one or more passengers, via one or more speakers of the vehicle in accordance with instructions provided by a processor of the vehicle;
capturing the passenger singing from the one or more singing zones, via one or more microphones of the vehicle in accordance with the instructions provided by the processor; and
outputting the passenger signing, overlayed with the music, to the one or more listening zones, via the one or more speakers in accordance with instructions provided by the processor.

2. The method of claim 1, further comprising:
performing, via the processor, voice processing for the passenger singing, thereby separating the passenger singing from other sounds including echoes of the music.

3. The method of claim 1, further comprising:
providing, via the processor, a sing-a-long game for the one or more passengers, in which the one or more passengers perform the singing along with the music as part of the sing-a-long game;
calculating, via the processor, a score for each of the one or more passengers, or for groups of the one or more passengers, based on the passenger singing of each of the one or more passengers or groups of passengers; and
providing, via the processor, instructions for outputting the score for the one or more passengers.

4. The method of claim 3, further comprising:
obtaining, via the one or more sensors of the vehicle, sensor data as to one or more environmental conditions in proximity to the vehicle; and
controlling, via the processor, the sing-a-long game based at least in part of the one or more environmental conditions.

5. The method of claim 3, wherein the calculating of the scoring is performed based on a comparison, via the processor of a passenger pitch of the passenger singing versus an original pitch of an original singer associated with the music.

6. The method of claim 3, wherein the calculating of the scoring is performed based on a comparison, via the processor of a passenger beat of the passenger singing versus an original beat of an original singer associated with the music.

7. The method of claim 3, wherein the calculating of the scoring is performed based on a comparison, via the processor of a passenger word accuracy of lyrics of the passenger singing versus an original word accuracy of lyrics of an original singer associated with the music.

8. The method of claim 3, wherein the calculating of the scoring is performed based on a weighted average of the following comparisons, each performed by the processor via machine learning using a neural network model and a signal processing method:
a first comparison of a passenger pitch of the passenger singing versus an original pitch of an original singer associated with the music;
a second comparison of a passenger beat of the passenger singing versus an original beat of the original singer associated with the music; and
a third comparison of a passenger word accuracy of lyrics of the passenger singing versus an original word accuracy of lyrics of the original singer associated with the music.

9. The method of claim 1, further comprising:
providing, via the processor, light enhancements that include illumination of ambient lights inside the vehicle in accordance with a first color for the one or more singing zones, and a second color that is different from the first color for the one or more listening zones.

10. A system comprising:
one or more sensors of a vehicle, the one or more sensors configured to obtain inputs from one or more passengers of the vehicle as to one or more singing zones for passenger singing along with music of the vehicle, and one or more listening zones for listening to the passenger singing;
a processor of the vehicle, the processor coupled to the one or more sensors and configured to provide instructions for musical sing-a-long in the vehicle;
one or more speakers of the vehicle, the one or more speakers configured to output the music for the one or more passengers in accordance with the instructions provided by the processor; and
one or more microphones of the vehicle, the one or more microphones configured to capture the passenger singing from the one or more singing zones in accordance with the instructions provided by the processor;
wherein the one or more speakers are further configured to output the passenger signing, overlayed with the music, to the one or more listening zones, in accordance with the instructions provided by the processor.

11. The system of claim 10, wherein the processor is further configured to at least facilitate performing voice processing for the passenger singing, thereby separating the passenger singing from other sounds including echoes of the music.

12. The system of claim 10, wherein the processor is further configured to at least facilitate:
providing a sing-a-long game for the one or more passengers, in which the one or more passengers perform the singing along with the music as part of the sing-a-long game;
calculating a score for each of the one or more passengers, or for groups of the one or more passengers, based on the passenger singing of each of the one or more passengers or groups of passengers; and
providing instructions for outputting the score for the one or more passengers.

13. The system of claim 12, wherein:
the one or more sensors are further configured to obtain sensor data as to one or more environmental conditions in proximity to the vehicle; and
the processor is further configured to at least facilitate controlling the sing-a-long game based at least in part of the one or more environmental conditions.

14. The system of claim 12, wherein the processor is further configured to at least facilitate calculating the scoring based on a comparison, via the processor of a passenger pitch of the passenger singing versus an original pitch of an original singer associated with the music.

15. The system of claim 12, wherein the processor is further configured to at least facilitate calculating the scoring based on a comparison of a passenger beat of the passenger singing versus an original beat of an original singer associated with the music.

16. The system of claim 12, wherein the processor is further configured to at least facilitate calculating the scoring based on a comparison of a passenger word accuracy of lyrics of the passenger singing versus an original word accuracy of lyrics of an original singer associated with the music.

17. The system of claim 12, wherein the processor is further configured to at least facilitate calculating the scoring is performed based on a weighted average of the following comparisons, each performed by the processor via machine learning using a neural network model and a signal processing method:
a first comparison of a passenger pitch of the passenger singing versus an original pitch of an original singer associated with the music;
a second comparison of a passenger beat of the passenger singing versus an original beat of the original singer associated with the music; and
a third comparison of a passenger word accuracy of lyrics of the passenger singing versus an original word accuracy of lyrics of the original singer associated with the music.

18. The system of claim 10, wherein the processor is further configured to at least facilitate providing light enhancements that include illumination of ambient lights inside the vehicle in accordance with a first color for the one or more singing zones, and a second color that is different from the first color for the one or more listening zones.

19. A vehicle comprising:
a body;
a propulsion system disposed within the body and configured to move the vehicle;
one or more sensors configured to obtain inputs from one or more passengers of the vehicle as to one or more singing zones for passenger singing along with music of the vehicle, and one or more listening zones for listening to the passenger singing;
a processor coupled to the one or more sensors and configured to provide instructions for musical sing-a-long in the vehicle;
one or more speakers of the vehicle, the one or more speakers configured to output the music for the one or more passengers in accordance with the instructions provided by the processor; and
one or more microphones of the vehicle, the one or more microphones configured to capture the passenger singing from the one or more singing zones in accordance with the instructions provided by the processor;
wherein the one or more speakers are further configured to output the passenger signing, overlayed with the music, to the one or more listening zones, in accordance with the instructions provided by the processor; and
wherein the processor is further configured to at least facilitate:
performing voice processing for the passenger singing, thereby separating the passenger singing from other sounds including echoes of the music;
providing a sing-a-long game for the one or more passengers, in which the one or more passengers perform the singing along with the music as part of the sing-a-long game;
calculating a score for each of the one or more passengers, or for groups of the one or more passengers, based on the passenger singing of each of the one or more passengers or groups of passengers; and
providing instructions for outputting the score for the one or more passengers.

20. The vehicle of claim 19, wherein the processor is further configured to at least facilitate calculating the scoring is performed based on a weighted average of the following comparisons, each performed by the processor via machine learning using a neural network model and a signal processing method:
a first comparison of a passenger pitch of the passenger singing versus an original pitch of an original singer associated with the music;
a second comparison of a passenger beat of the passenger singing versus an original beat of the original singer associated with the music; and
a third comparison of a passenger word accuracy of lyrics of the passenger singing versus an original word accuracy of lyrics of the original singer associated with the music.
